(19) United States
(12) Patent Application Publication
(10) Pub. No.: US 2010/0265929 A1
(43) Pub. Date: Oct. 21, 2010

(54) METHOD FOR DETERMINING A MODULATION AND CODING SCHEME

(75) Inventors: YEN CHIN LIAO, HSINCHU COUNTY (TW); YUNG SZU TU, HSINCHU COUNTY (TW); CHENG HSUAN WU, HSINCHU COUNTY (TW); JIUNN TSAIR CHEN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/571,071

(22) Filed: Sep. 30, 2009

(30) Foreign Application Priority Data
Apr. 20, 2009 (TW) 098112960

(51) Int. Cl. H04W 40/00

(52) U.S. Cl. 370/338

(57) ABSTRACT

A method for determining a modulation and coding scheme for signals with packets of different lengths comprises the steps of: grouping signals according to their packet lengths, wherein each group has a weighting for each modulation and coding scheme; transmitting signals with different modulation and coding schemes; adjusting weights of each modulation and coding scheme of each group according to the quality of receiving the transmitted signals; determining a modulation and coding scheme according to the weightings of each modulation and coding scheme in the group corresponding to the packet length of the signal to be transmitted.

### BACKGROUND OF THE INVENTION

1. Field of the Invention

The present invention relates to a method for determining a modulation and coding scheme of a communication system, and more particularly, to a method for determining a modulation and coding scheme for signals with packets of different lengths.

2. Description of the Related Art

In wireless local area networks, such as those following the IEEE 802.11n standard, a receiver is required to suggest transmitter modulation and coding schemes (MCS) based on transmission environment. And the MCS adopted by the transmitter is selected according to variations in the transmission environment so as to maintain optimal transmission throughput.

A popular MCS selection method is based on the transmission environment; that is, selecting the MCS for the transmitter based on the signal-to-noise ratio (SNR). For example, FIG. 1 shows experiment results of the optimum MCSs for different SNRs in an IEEE 802.11n wireless communication system. As shown in FIG. 1, the system structure is a double antenna system, wherein a double transmission antenna and a double receiving antenna are included. There are 16 MCSs available, of which number 0 to number 7 are single spatial stream MCS, and number 8 to number 15 are double spatial stream MCS. The receiver stores the experiment results shown in FIG. 1 in a table and selects the MCS adopted by the transmitter according to the stored experiment results.

Theoretically, a transmitted signal with a long packet length would exhibit a high packet error rate (PER). FIG. 2 shows the PER versus SNR of transmitted signals with different packet lengths and MCSs. As shown in FIG. 2, for the transmitted signals in the same transmission environment, for example, for the transmitted signal in the transmission environment with SNR equal to 2, the signal with packet length of L and MCS of MCSi and the signal with packet length of 16 L and MCS of MCS(i+1) exhibit similar packet correct rates. On the other hand, for the transmitted signals in the same transmission environment and with the same packet lengths, such as for the transmitted signals in the transmission environment with SNR equal to 2 and exhibiting packet length of L, the signal with MCS of MCS(i+1) exhibits a higher packet correct rate than the signal with MCS of MCSi.

However, the aforementioned methods for determining a MCS all fail to make adjustment based on packets of the transmitted signals. Accordingly, there is need to adjust the MCS of the transmitted signals if the transmitted signals are applied to communication systems allowing is different packet lengths. For a system complying with the IEEE 802.11n standard, the longest allowable packet length is 64 KB. Two transmitted signals with different packet lengths would exhibit different PERs, even if both utilize the same MCS. However, if the MCS of the transmitted signals is determined based on the statistics of the PERs for all the transmitted signals regardless of packet length or MCS, the generation of such statistics would take too long to be practical.

Therefore, there is a need to design a high-speed and easily-implemented method for determining a MCS of a communication system allowing different packet lengths such that the determining criteria of the method take into account of the packet lengths of the transmitted signals.

### SUMMARY OF THE INVENTION

The method for determining a modulation and coding scheme for signals of the present invention records the weightings of each MCS and different packet lengths, and updates these weightings according to the receiving quality of a transmitted signal.

The method for determining a MCS for signals according to one embodiment of the present invention comprises the steps of: grouping signals according to their packet lengths, wherein each group has a weighting for each MCS; transmitting signals with different MCSs; adjusting the weightings of each MCS of each group according to the quality of receiving the transmitted signals; and determining a MCS according to the weightings of the MCSs in the group corresponding to a packet length of a signal to be transmitted.

The method for determining a MCS for signals according to one embodiment of the present invention comprises the steps of: grouping signals according to their packet lengths, wherein each group has a weighting for each MCS; transmitting a signal according to a MCS and a packet length, and receiving the ACK signal corresponding to the transmitted signal; increasing the weightings of the MCSs with the same packet length of the MCS of the transmitted signal and data rate equal to or higher than that of the MCS of the transmitted signal, increasing the weightings of the MCSs with packet length shorter than that of the MCS of the transmitted signal and data rate equal to or higher than that of the MCS of the transmitted signal, and decreasing the weightings of the MCSs with the same packet length of the MCS of the transmitted signal and data rate smaller than that of the MCS of the transmitted signal, if the ACK signal corresponding to the transmitted signal is 1; decreasing the weightings of the MCSs with the same packet length of the MCS of the transmitted signal and data rate equal to or higher than that of the MCS of the transmitted signal, decreasing the weightings of the MCSs with packet length equal to or longer than that of the MCS of the transmitted signal and data rate equal to or higher than that of the MCS of the transmitted signal, and increasing the weightings of the MCSs with the same packet length of the MCS of the transmitted signal and data rate smaller than that of the MCS of the transmitted signal, if the ACK signal corresponding to the transmitted signal is 0; selecting a MCS according to the weightings of the MCSs in the group corresponding to a packet length of a signal to be transmitted, and repeating the transmitting step; and determining a MCS according to the weightings of the MCSs in the group corresponding to a packet length of a signal to be transmitted.

### BRIEF DESCRIPTION OF THE DRAWINGS

The objectives and advantages of the present invention will become apparent upon reading the following description and upon referring to the accompanying drawings of which:

FIG. 1 shows experiment results of the optimum modulation and coding schemes for different SNRs;

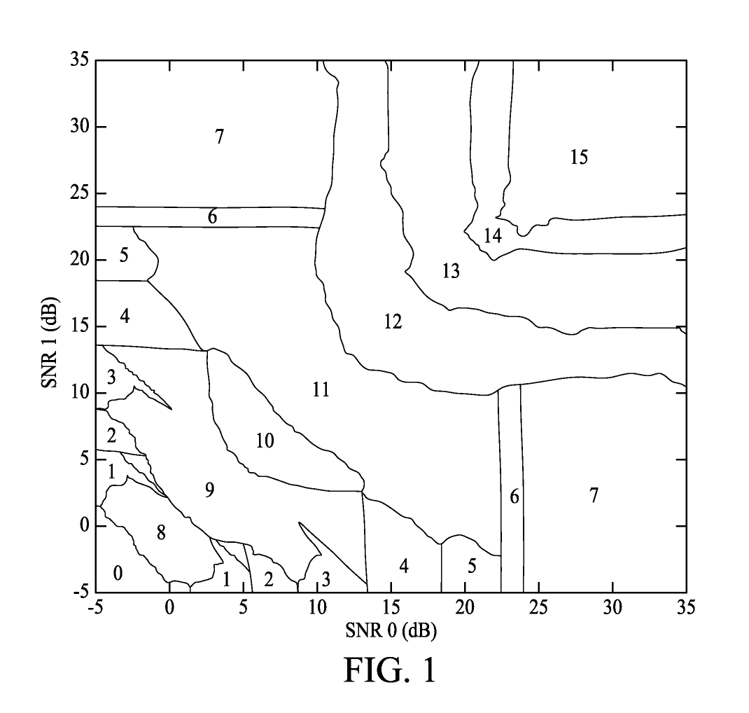

FIG. 2 shows PER versus SNR of transmitted signals with different packet lengths and modulation and coding schemes; and

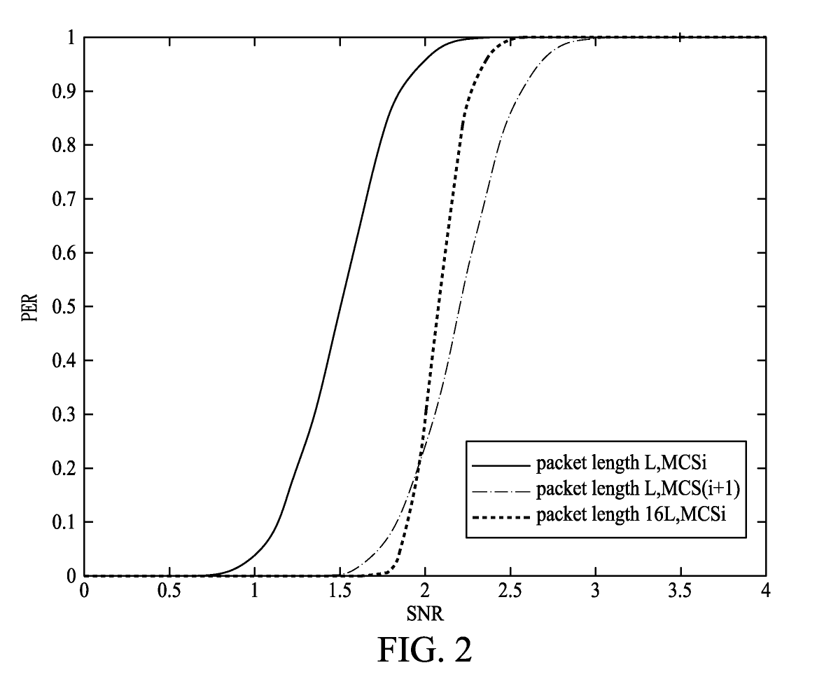

FIG. 3 shows a flow chart of a method for determining a modulation and coding scheme according to an embodiment of the present invention.

### DETAILED DESCRIPTION OF THE INVENTION

In one embodiment of the present invention complying with the IEEE 802.11n standard, the qualities of received signals with different packet lengths and different modulation and coding schemes (MCS) are recorded. Such recording does not need to record the corresponding signals for each allowable packet length, and can instead record only a group of signals having similar packet lengths together so as to reduce the convergence time of the determining procedure. For example, for a system with the longest allowable packet length of 64 KB, all of the signals are divided into several groups such that the packet length of each signal in one group may differ from the packet length of another signal in the same group no more than 4 KB. Therefore, all of the signals are categorized into groups of 0 KB-4 KB, 4 KB-8 KB to 60 KB-64 KB, a total of 16 groups. Theoretically, the determining procedure with coarser grouping exhibits a faster convergence speed, and the determining procedure with finer grouping produces a more accurate result.

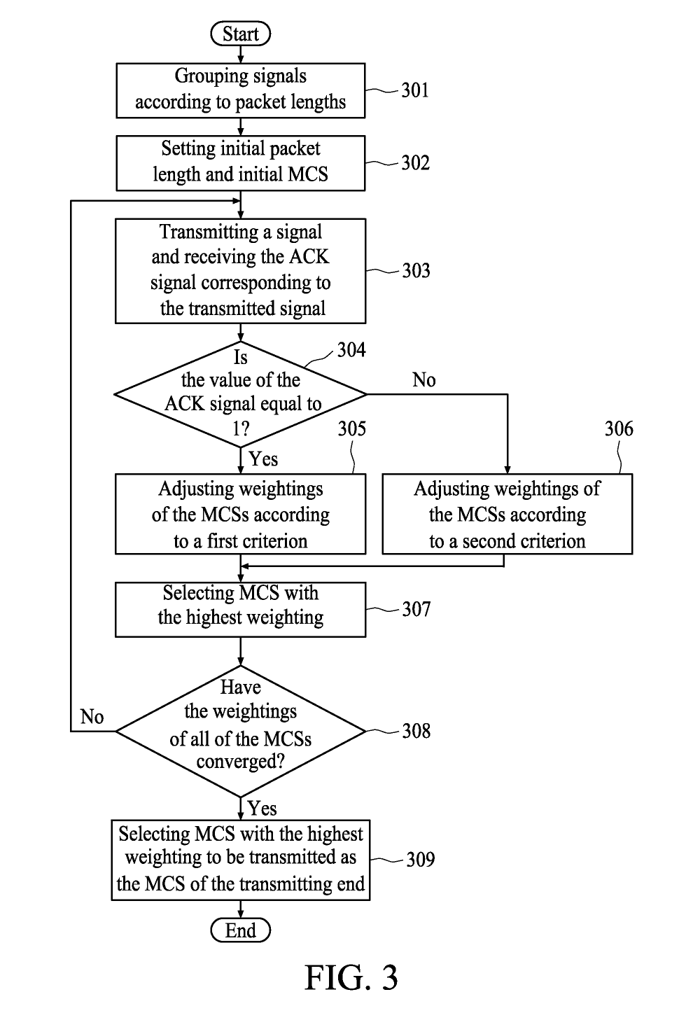

FIG. 3 shows a flow chart of a method for determining a MCS for signals according to an embodiment of the present invention. In step 301, signals are grouped according to their packet lengths, wherein each group has a weighting for each MCS, and step 302 is executed. In step 302, an initial packet length and an initial MCS are set, and step 303 is executed. In step 303, a signal is transmitted according to selected packet length and MCS, the ACK signal corresponding to the transmitted signal is received, and step 304 is executed. In step 304, the value of the ACK signal is determined. If the value of the ACK signal is 1, step 305 is executed; otherwise, step 306 is executed. In step 305, a first criterion is applied, the weightings of the MCSs with the same packet length of the MCS of the transmitted signal and data rate equal to or higher than that of the MCS of the transmitted signal are increased, the weightings of the MCSs with packet length shorter than that of the MCS of the transmitted signal and data rate equal to or higher than that of the MCS of the transmitted signal are increased, the weightings of the MCSs with the same packet length of the MCS of the transmitted signal and data rate lower than that of the MCS of the transmitted signal are decreased, and step 307 is executed. In step 306, a second criterion is applied, the weightings of the MCSs with the same packet length of the MCS of the transmitted signal and data rate equal to or higher than that of the MCS of the transmitted signal are decreased, the weightings of the MCSs with packet length equal to or longer than that of the MCS of the transmitted signal and data rate equal to or higher than that of the MCS of the transmitted signal are decreased, the weightings of the MCSs with the same packet length of the MCS of the transmitted signal and data rate lower than that of the MCS of the transmitted signal are increased, and step 307 is executed. In step 307, based on the packet length of the signals to be transmitted, a MCS with the highest weighting is selected, and step 308 is executed, wherein in step 307, if there are more than one MCSs with the highest weightings, the MCS with the highest data rate is selected. In step 308, it is determined whether the weightings of all of the MCSs have converged. If the result is positive, step 309 is executed; otherwise, step 303 is re-executed. In step 309, based on the packet length of the signals to be transmitted, a MCS with the highest weighting is selected as the MCS of the transmitting end.

In some of the embodiments of the present invention, a single spatial stream MCS is initiated in step 302. After the weightings of all of the MCSs are determined as converged, the number of the spatial streams of the transmitted signal is increased, and step 301 is re-executed.

The following exemplifies an embodiment of the present invention utilized in an IEEE 802.11n communication system. The communication system exhibits at least two antennas, and has 16 MCSs, of which number 0 to number 7 are single spatial stream MCSs, and number 8 to number 15 are double spatial stream MCSs. The packet lengths available for use of the communication system are between 0 and 64 KB.

In step 301, signals with different packet lengths are categorized into groups of 0 KB-4 KB, 4 KB-8 KB, . . . to 60 KB-64 KB, a total of 16 groups, wherein each group comprises a vector Vk with initial value of 0 and length of 8, and k is an integer ranging from 1 to 16. The values stored in Vk represent the weightings of the MCSs MCS0 to MCS7, wherein the order of these MCSs in the vector Vk is listed according to data rate, and the MCS with the lowest data rate is listed at the leftmost entry.

In step 302, an initial packet length and an initial MCS of single spatial stream are set, e.g., a packet length of 17 KB and a MCS of MCS4 are set. In step 303, a signal is transmitted according to the selected MCS MCS4 and the ACK signal corresponding to the transmitted signal is received. In step 304, the ACK signal corresponding to the transmitted signal is determined as 1, and step 304 is executed. The calculation of the weightings of the MCSs in steps 305 and 306 is based on the following pseudo code:

If (Ack==1)

Vk[m]=Vk[m]+1; for all m≧mcs

Vk[m]=Vk[m]−1; for all m<mcs

Vi[m]=Vi[m]+1; for all m≧mcs, i≦k

Else

Vk[m]=Vk[m]−1; for all m≧mcs

Vk[m]=Vk[m]+1; for all m<mcs

Vi[m]=Vi[m]−1; for all m≧mcs, i≧k, wherein Ack is the ACK signal corresponding to the transmitted signal, m is an integer ranging from 0 to 7, k is the group number of the groups of the signals, and mcs is the selected MCS. Accordingly, in step 305, the values of V5[4] to V5[7] are increased, the values of V5 [0] to V5 [3] are decreased, and the values of the fifth entry to the eighth entry of the vectors V1 to V4 are increased. Therefore, the values stored in V1 to V4 are all [0, 0, 0, 0, 1, 1, 1, 1], the is values stored in V5 are [−1, −1, −1, −1, 2, 2, 2, 2], and the values stored in V6 to V16 are all [0, 0, 0, 0, 0, 0, 0, 0].

In step 307, based on the packet length of the signals to be transmitted, a MCS with the highest weighting is selected. If the packet length of the signals to be transmitted is 64 KB, then the vector V16 is referenced, and the MCS with the highest weighting is selected. Since all of the weightings stored in vector V16 are 0, the MCS with the highest data rate is selected, i.e., MCS7. In step 308, the weightings of all of the MCSs are determined as not converged, thus step 303 is re-executed, and a signal with packet length 64 KB and MCS MCS7 is transmitted.

However, this time, the ACK signal corresponding to the transmitted signal is determined as 0 in step 304, and step 306 is executed. Accordingly, the values of V16[7] are decreased, the values of V16[0] to V16[6] are increased, and the values of V16[7] are decreased again. Therefore, the values stored in V1 to V4 are all [0, 0, 0, 0, 1, 1, 1, 1], the values stored in V5 are [−1, −1, −1, −1, 2, 2, 2, 2], the values stored in V6 to V15 are all [0, 0, 0, 0, 0, 0, 0, 0], and the values stored in V16 are [1, 1, 1, 1, 1, 1, 1, −2].

After the weightings of all of the MCSs are determined as converged, i.e., there is a stable highest MCS in each group, the number of spatial streams is increased to 2, and step 301 is re-executed.

According to simulation results, compared with the method which only records the weightings of all of the MCSs without considering the packet length, the method for determining a MCS of the present invention exhibits significant improvement. That is, as shown in the simulation results, the signals transmitted based on the MCS selected by the method of the present invention exhibits a lower transmission throughput loss.

In conclusion, the method for determining a MCS of the present is invention not only considers the packet length, but also updates the weightings of the MCSs with different packet lengths when a signal is transmitted by an easy-to-realize method. That is, the method for determining a MCS of the present invention significantly reduces the transmission throughput loss with only a slight computational increase at the transmitting end.

The above-described embodiments of the present invention are intended to be illustrative only. Those skilled in the art may devise numerous alternative embodiments without departing from the scope of the following claims.

What is claimed is:

1. A method for determining a modulation and coding scheme for signals, comprising the steps of:
grouping signals according to packet lengths, wherein each group has a weighting for each modulation and coding scheme;
transmitting signals with different modulation and coding schemes;
adjusting the weighting of each modulation and coding scheme of each group according to the quality of receiving the transmitted signals; and
determining a modulation and coding scheme according to the weightings of the modulation and coding schemes in the group corresponding to a packet length of a signal to be transmitted.

2. The method of claim 1, wherein the quality of receiving the transmitted signals is evaluated by the ACK signals corresponding to the transmitted signals.

3. The method of claim 1, wherein the modulation and coding schemes have the same number of spatial streams.

4. The method of claim 1, further comprising the step of:
changing the number of spatial streams after the weightings of the modulation and coding schemes converge.

5. The method of claim 1, which is utilized in a double-antenna system.

6. The method of claim 1, which is utilized in an Institute of Electrical and Electronics Engineers (IEEE) 802.11n system.

7. A method for determining a modulation and coding scheme for signals, comprising the steps of:
grouping signals according to packet lengths, wherein each group has a weighting for each modulation and coding scheme;
transmitting a signal according to a modulation and coding scheme and a packet length, and receiving an ACK signal corresponding to the transmitted signal;
increasing the weightings of the modulation and coding schemes with the same packet length of the modulation and coding scheme of the transmitted signal and data rate equal to or higher than that of the modulation and coding scheme of the transmitted signal, increasing the weightings of the modulation and coding schemes with packet length shorter than that of the modulation and coding scheme of the transmitted signal and data rate equal to or higher than that of the modulation and coding scheme of the transmitted signal, and decreasing the weightings of the modulation and coding schemes with the same packet length of the modulation and coding scheme of the transmitted signal and data rate is smaller than that of the modulation and coding scheme of the transmitted signal, if the ACK signal corresponding to the transmitted signal is 1;
decreasing the weightings of the modulation and coding schemes with the same packet length of the modulation and coding scheme of the transmitted signal and data rate equal to or higher than that of the modulation and coding scheme of the transmitted signal, decreasing the weightings of the modulation and coding schemes with packet length equal to or longer than that of the modulation and coding scheme of the transmitted signal and data rate equal to or higher than that of the modulation and coding scheme of the transmitted signal, and increasing the weightings of the modulation and coding schemes with the same packet length of the modulation and coding scheme of the transmitted signal and data rate smaller than that of the modulation and coding scheme of the transmitted signal, if the ACK signal corresponding to the transmitted signal is 0;
selecting a modulation and coding scheme according to the weightings of the modulation and coding schemes in the group corresponding to a packet length of a signal to be transmitted, and repeating the transmitting step; and
determining a modulation and coding scheme according to the weightings of the modulation and coding schemes in the group corresponding to a packet length of a signal to be transmitted.

8. The method of claim 7, wherein the quality of receiving the transmitted signals is evaluated by the ACK signals corresponding to the transmitted signals.

9. The method of claim 7, wherein the modulation and coding schemes have the same number of spatial streams.

10. The method of claim 7, wherein the selecting step selects the modulation and coding scheme with a highest weighting in the group corresponding to the packet length of the signal to be transmitted.

11. The method of claim 10, wherein if there are more than one is modulation and coding schemes with the highest weighting, then the modulation and coding scheme with the highest data rate is selected.

12. The method of claim 7, wherein the determining step determines the modulation and coding scheme with a highest weighting in the group corresponding to the packet length of the signal to be transmitted.

13. The method of claim 7, wherein if the ACK signal corresponding to the transmitted signal is 1, the weightings of the modulation and coding schemes with the same packet length of the modulation and coding scheme of the transmitted signal and data rate equal to or higher than that of the modulation and coding scheme of the transmitted signal are incremented by 1, the weightings of the modulation and coding schemes with packet length shorter than that of the modulation and coding scheme of the transmitted signal and data rate equal to or higher than that of the modulation and coding scheme of the transmitted signal are incremented by 1, and the weightings of the modulation and coding schemes with the same packet length of the modulation and coding scheme of the transmitted signal and data rate smaller than that of the modulation and coding scheme of the transmitted signal are decremented by 1.

14. The method of claim 7, wherein if the ACK signal corresponding to the transmitted signal is 0, the weightings of the modulation and coding schemes with the same packet length of the modulation and coding scheme of the transmitted signal and data rate equal to or higher than that of the modulation and coding scheme of the transmitted signal are decremented by 1, the weightings of the modulation and coding schemes with packet length equal to or longer than that of the modulation and coding scheme of the transmitted signal and data rate equal to or higher than that of the modulation and coding scheme of the transmitted signal are decremented by 1, and the weightings of the modulation and coding schemes with the same packet length of the is modulation and coding scheme of the transmitted signal and data rate smaller than that of the modulation and coding scheme of the transmitted signal are incremented by 1.

15. The method of claim 7, wherein the weightings of the modulation and coding schemes are recorded in vector forms.

16. The method of claim 7, further comprising the step of:
changing the number of spatial streams after the weightings of the modulation and coding schemes converge.

17. The method of claim 7, which is utilized in a double-antenna system.

18. The method of claim 7, which is utilized in an IEEE 802.11n system.
